(19) United States
(12) Patent Application Publication
(10) Pub. No.: US 2026/0199916 A1
(43) Pub. Date: Jul. 16, 2026

(54) PULSE VALVE AND COATING APPARATUS

(71) Applicants: Daisuke ASAHINA, Kanagawa (JP); Hideaki NISHIMURA, Kanagawa (JP); Satoshi SHINOHARA, Ibaraki (JP)

(72) Inventors: Daisuke ASAHINA, Kanagawa (JP); Hideaki NISHIMURA, Kanagawa (JP); Satoshi SHINOHARA, Ibaraki (JP)

(21) Appl. No.: 19/132,388

(22) PCT Filed: Nov. 10, 2023
(86) PCT No.: PCT/IB2023/061357

§ 371 Date: May 23, 2025

(30) Foreign Application Priority Data
Nov. 29, 2022 (JP) 2022-190254
Sep. 29, 2023 (JP) 2023-170614

(51) Int. Cl. B05B 7/12; B05B 7/04

(52) U.S. Cl. CPC B05B 7/12; B05B 7/0416

(57) ABSTRACT

A pulse valve includes: a housing having: a channel through which a fluid flows in a discharge direction; and a hole recessed toward the channel in an opposite direction opposite to the discharge direction; and a nozzle, fitted into the hole in the opposite direction, the nozzle including: a nozzle pipe having: a nozzle hole, at one end of the nozzle pipe in the discharge direction, from which the fluid flowing through the channel is discharged in the discharge direction; and another end communicating with the channel in the discharge direction; and a connection ferrule at a periphery of the nozzle pipe and fixed to the housing.

### TECHNICAL FIELD

Embodiments of the present disclosure relate to a pulse valve and a coating apparatus.

### BACKGROUND ART

Some coating technologies that change volatile organic compounds (VOC) for a supercritical fluid such as supercritical carbon dioxide in a drying process of a coating material are known. Further, a pulse valve for discharging a supercritical fluid in the form of gas has been proposed (e.g., PTL 1).

### SUMMARY OF INVENTION

### Citation List

### Patent Literature

### [PTL 1]

Japanese Unexamined Patent Application Publication No. 2009-30669

### SUMMARY OF INVENTION

### Technical Problem

A pulse valve for discharging a supercritical fluid is required to have pressure resistance for maintaining a high pressure of the supercritical fluid.

An object of the present disclosure is to provide a pulse valve having high-pressure resistance.

### Solution to Problem

According to an embodiment of the present disclosure, a pulse valve includes: a housing having: a channel through which a fluid flows in a discharge direction; and a hole recessed toward the channel in an opposite direction opposite to the discharge direction; and a nozzle, fitted into the hole in the opposite direction, the nozzle including: a nozzle pipe having: a nozzle hole, at one end of the nozzle pipe in the discharge direction, from which the fluid flowing through the channel is discharged in the discharge direction; and another end communicating with the channel in the discharge direction; and a connection ferrule at a periphery of the nozzle pipe and fixed to the housing.

According to an embodiment of the present disclosure, a coating apparatus includes: the pulse valve according to the first or second aspect to discharge the fluid from the nozzle hole; a pressure container to: mix a compressed fluid and a resin to generate the fluid; and supply the fluid to the pulse valve.

### Advantageous Effects of Invention

According to one aspect of the present disclosure, the pressure resistance of a pulse valve can be increased.

### BRIEF DESCRIPTION OF DRAWINGS

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

FIG. 1 is a schematic diagram illustrating an overall configuration of a coating apparatus according to a first embodiment of the present disclosure;

FIG. 2 is a schematic cross-sectional view of a pulse valve in the coating apparatus according to the first embodiment;

FIG. 3 is a part of a cross-sectional view of a part of the pulse valve illustrated in FIG. 2;

FIG. 4 is a schematic cross-sectional view of a pulse valve according to a second embodiment of the present disclosure;

FIG. 5 is an A-A sectional view of the pulse valve of FIG. 5;

FIG. 6 is a schematic cross-sectional view of a pulse valve according to a third embodiment of the present disclosure;

FIG. 7 is a schematic cross-sectional view of a pulse valve according to a first modification of the third embodiment of the present disclosure; and

FIG. 8 is a schematic cross-sectional view of a pulse valve according to a second modification of the third embodiment of the present disclosure.

### DESCRIPTION OF EMBODIMENTS

The terminology used herein is for the purpose of describing particular embodiments only and is not intended to be limiting of the present invention. As used herein, the singular forms “a,” “an,” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Embodiments of the present disclosure will be described below with reference to the drawings. In the drawings, the same or like reference signs denote like elements having substantially the same or corresponding configurations, and descriptions thereof may be omitted.

### First Embodiment

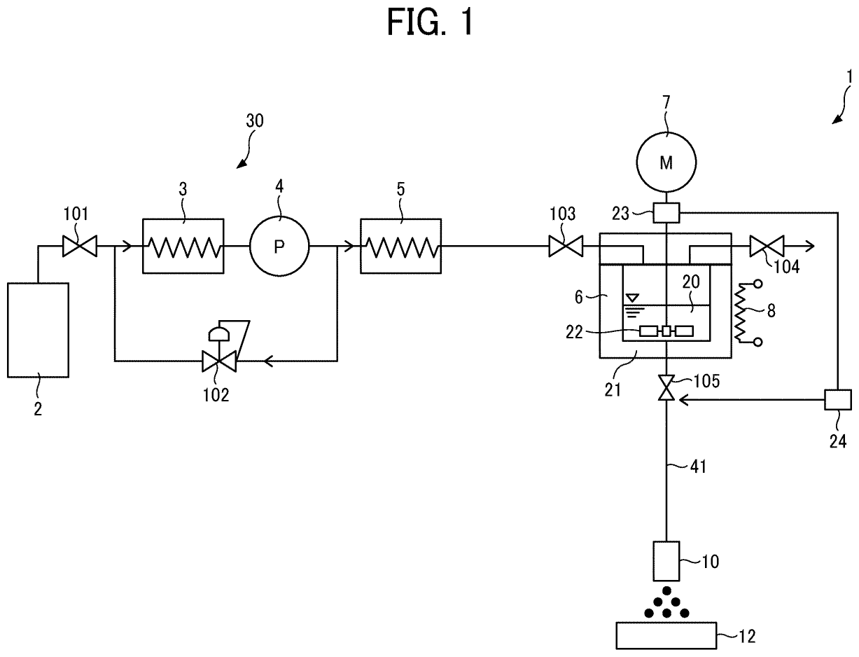

A coating apparatus 1 according to a first embodiment of the present disclosure will be described below with reference to FIG. 1.

### Overall Configuration of Coating Apparatus

FIG. 1 is a schematic diagram illustrating an overall configuration of the coating apparatus 1 according to a first embodiment of the present disclosure. The coating apparatus 1 includes: a generator 30 that generates supercritical carbon dioxide, a high-pressure container 6 (pressure container) that mixes the supercritical carbon dioxide generated by the generator 30 with a resin to obtain a mixture of the supercritical carbon dioxide and the resin, a pulse valve 10 that discharges the mixture supplied from the high-pressure container 6 to a base material 12, and a pipe 41 that connects the high-pressure container 6 and the pulse valve 10.

Supercritical carbon dioxide serves as a “compressed fluid”. The term “compressed fluid” includes a supercritical fluid and a subcritical fluid. As a compressed fluid, for example, supercritical carbon dioxide as a supercritical fluid will be described below, but the applicable compressed fluid is not limited to the supercritical carbon dioxide. Further, examples of the supercritical fluid include supercritical water and supercritical nitrogen. These supercritical fluids are preferable because these supercritical fluids have less environmental load and are less expensive. A mixture of supercritical carbon dioxide and a resin may be referred to as “a mixture”.

In at least some embodiments, a coating apparatus includes: the pulse valve to discharge the fluid from the nozzle hole; a pressure container to: mix a compressed fluid and a resin to generate the fluid; and supply the fluid to the pulse valve.

In at least some embodiments, in the coating apparatus, a pressure container includes: the stirrer to stir a mixture of the compressed fluid and the resin to generate the fluid; and a torque meter to measure torque of the stirrer generated by stirring the mixture.

A resin mixed with supercritical carbon dioxide may be a thermosetting resin or a thermoplastic resin. Examples of thermosetting resins include phenolic resins, epoxy resins, melamine resins, urea resin, unsaturated polyester resins, silicone resins, polyurethane resins, thermosetting polyimide resins, and thermosetting furan resins. Examples of thermoplastic resins include polyester resins, polyethylene resins, polypropylene resins, acrylonitrile butadiene styrene resins, acrylic (PMMA) resins, and polyamide resins.

A colored coating film may be formed by mixing a dye and a pigment with a resin. However, in order to avoid the generation of volatile organic compounds (VOC), it is preferable that a mixture in the present embodiment does not contain an organic solvent.

Examples of the base material 12 to be coated with the mixture include resin materials, metal materials, and porous materials containing carbon fibers, glass fibers, and cellulose fibers.

As illustrated in FIG. 1, in an embodiment of the present disclosure, the generator 30 includes a cylinder 2 that stores liquid carbon dioxide, a cooler 3 that cools the liquid carbon dioxide supplied from the cylinder 2 via a high-pressure valve 101 to a temperature lower than the saturation temperature, a high-pressure pump 4 that pressurizes the liquid carbon dioxide to a predetermined pressure, a heater 5 that heats the liquid carbon dioxide supplied from the high-pressure pump 4 to a predetermined temperature, and a back pressure valve 102 that returns excess liquid carbon dioxide out of the liquid carbon dioxide supplied from the high-pressure pump 4 to a downstream area from the high-pressure pump 4.

Examples of the cooler 3 include a chiller device that circulates cooling water to cool an object to be cooled. Further, examples of the high-pressure pump 4 include a double plunger pump that can control the liquid discharge amount and prevent pulsation. However, the cooler 3 and the high-pressure pump 4 are not limited thereto.

Supercritical carbon dioxide is generated by heating the liquid carbon dioxide pressurized by the high-pressure pump 4 by the heater 5.

The high-pressure container 6 mixes the supercritical carbon dioxide supplied from the generator 30 via a high-pressure valve 103 with a resin under a high-pressure environment. The resin is supplied through a channel different from a channel though which the supercritical carbon dioxide is supplied. Examples of the high-pressure container 6 include an autoclave. However, the high-pressure container is not limited thereto.

The high-pressure container 6 includes a container body 21 that accommodates supercritical carbon dioxide and a resin, a stirrer 22 that stirs the supercritical carbon dioxide and the resin to be introduced into the container body 21, a motor 7 that drives the stirrer 22, and a torque meter 23 that measures the rotational force of the stirrer 22.

Examples of the stirrer 22 include magnetic impellers (i.e., impellers rotated by the driving force from a motor), single-axis screws, intermeshing two-axis screws, two-axis mixers with multiple intermeshing or overlapping stirring elements, kneaders with intermeshing helical stirring elements, and static mixers. Preferably, the high-pressure container 6 further includes a heater 8 that heats the container and a high-pressure valve 104 that opens the container to the atmosphere.

In the initial stage of mixing the supercritical carbon dioxide and the resin in the high-pressure container 6, the supercritical carbon dioxide and the resin are not sufficiently mixed. Thus, the viscosity of the mixture is high, and the torque of the stirrer 22 is high. However, as the mixing of the supercritical carbon dioxide and the resin proceeds, the viscosity of the mixture decreases. Accordingly, the torque of the stirrer 22 also decreases. Further, since the supercritical carbon dioxide and the resin are sufficiently mixed, the viscosity of the mixture further decreases, and then the decrease in the viscosity stops. Accordingly, the torque of the stirrer 22 becomes also constant. In other words, by detecting that the torque of the stirrer 22 becomes constant by the torque meter 23, it can be determined that the supercritical carbon dioxide and the resin are sufficiently mixed.

In the high-pressure container 6, supercritical carbon dioxide and resin are mixed under a high pressure of, for example, about 50 megapascal (MPa) to 60 MPa. Thus, the progress of mixing the supercritical carbon dioxide and the resin cannot be visually inspected under normal operating conditions, for example, by opening the lid of the high-pressure container 6. On the other hand, according to the configuration in which the transition of the torque of the stirrer 22 is measured by using the torque meter 23 as in the present embodiment, uniform mixing of the supercritical carbon dioxide and the resin can be determined without visually inspecting the inside of the high-pressure container 6. As a result, an unmixed resin can be prevented from being supplied to the pulse valve 10, and discharge failure of the pulse valve 10 can be prevented.

The torque meter 23 may output a torque measurement signal of the stirrer 22 to a controller 24. Further, the controller 24 may determine whether the supercritical carbon dioxide and the resin are uniformly mixed based on the torque measurement signal of the torque meter 23. Further, the controller 24 may control the opening and closing of the high-pressure valve 105 disposed downstream from the high-pressure container 6 based on the determination result.

The high-pressure valve 105 is disposed downstream from the high-pressure container 6 in a direction in which the mixture of the supercritical carbon dioxide and the resin is supplied to the pulse valve 10. When the high-pressure valve 105 is opened, the mixture in the high-pressure container 6 passes through the pipe 41 and is supplied to the pulse valve 10.

Preferably, a heater or a heat insulator is disposed around the pipe 41. As a result, the pipe 41 can be maintained at a predetermined temperature, and the supercritical state of the carbon dioxide flowing through the pipe 41 can be maintained and the fluidity can be increased.

The pulse valve 10 is connected to the end of the pipe 41. Accordingly, the pulse valve 10 and the pipe 41 communicate with each other, and the mixture flowing through the pipe 41 is introduced into the pulse valve 10. The pulse valve 10 discharges the introduced mixture to the base material 12.

A mixture having a temperature exceeding, for example, 200° C. (e.g., temperature of 250° C.) and a pressure of about 50 MPa to 60 MPa is introduced into the pulse valve 10. The pulse valve 10 discharges the mixture toward the base material 12 while maintaining the temperature and the pressure at the time of introduction of the mixture. Further, the pulse valve 10 performs an opening-and-closing operation at high speed so that the opening time becomes, for example, 100 microseconds (μs) or less. Thus, the pulse valve 10 stably discharges a preferable amount of the mixture. The pulse valve 10 will be described in detail in the following description of Configuration of Pulse Valve.

### Operation of Coating Apparatus

With reference to FIG. 1, the discharging operation of the mixture in the coating apparatus 1 will be described. The liquid carbon dioxide stored in the cylinder 2 is cooled to the saturation temperature or lower by the cooler 3 via the high-pressure valve 101.

The supercritical carbon dioxide that has passed through the cooler 3 is introduced into a suction section of the high-pressure pump 4. The liquid carbon dioxide introduced into the high-pressure pump 4 from the suction section is pressurized to a predetermined pressure (e.g., 7.3 MPa of the critical pressure of carbon dioxide) or higher in the high-pressure pump 4. During the constant pressure operation, the liquid carbon dioxide introduced into the high-pressure pump 4 is returned to the suction section of the high-pressure pump 4 by the back pressure valve 102.

The pressurized liquid carbon dioxide is heated by the heater 5 to a predetermined temperature (e.g., 31° C. of the critical temperature of carbon dioxide) or higher. As a result, supercritical carbon dioxide is produced from liquid carbon dioxide.

The generated supercritical carbon dioxide is introduced into the high-pressure container 6 heated to a predetermined temperature by the heater 8 via the high-pressure valve 103. The supercritical carbon dioxide is melted and mixed with the resin introduced into the high-pressure container 6 through another channel by the stirrer 22 connected to the motor 7.

At this time, the mixture is heated to, for example, about 250° C. by the heater 8. Further, the mixture is pressurized to a pressure of, for example, about 50 MPa to 60 MPa by a predetermined pressurizing mechanism.

In the present embodiment, a mixture of supercritical carbon dioxide and resin is obtained through a process of mixing the supercritical carbon dioxide and the resin. Whether a uniform mixture is obtained is determined by the measurement value of the torque meter 23 that measures the torque of the stirrer 22.

Then, the high-pressure valve 105 is opened. Accordingly, the mixture in the high-pressure container 6 flows toward the pulse valve 10 through the pipe 41. Further, the pulse valve 10 repeatedly opens and closes a valve disposed in the pulse valve 10 while maintaining the temperature and the pressure of the introduced mixture, and discharges a desired amount of the mixture to the base material 12.

### Configuration of Pulse Valve

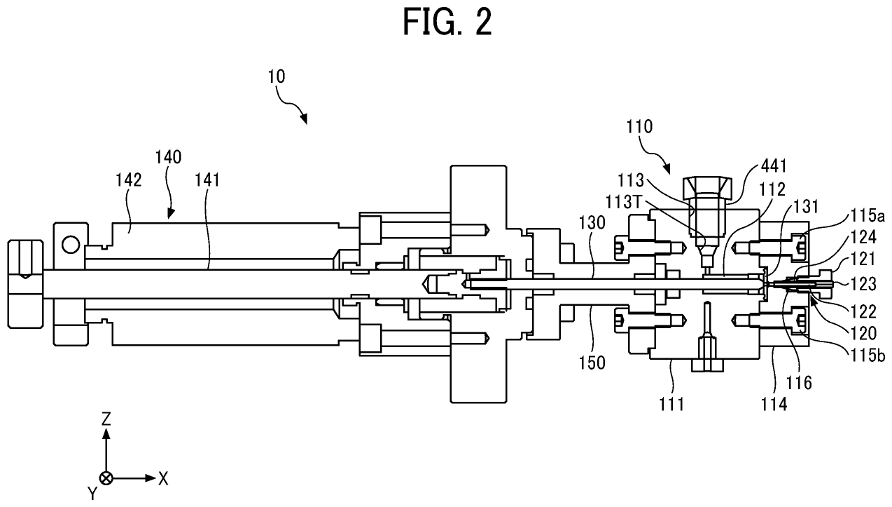

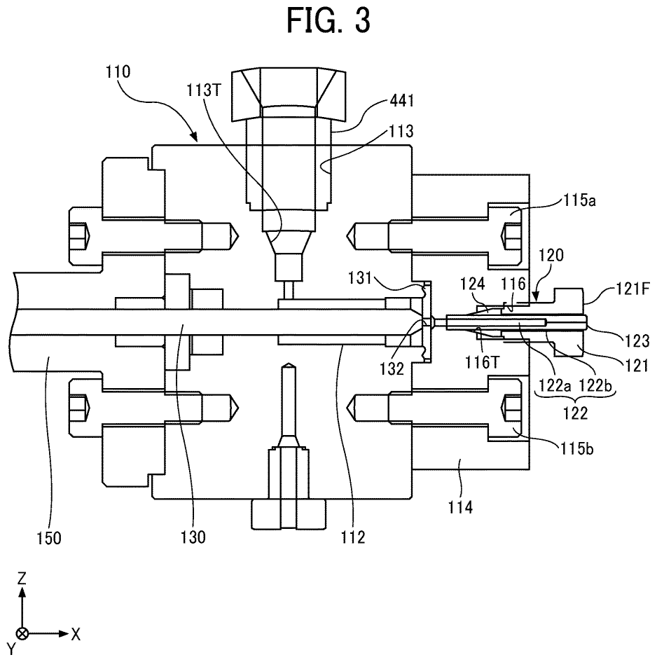

The configuration of the pulse valve 10 of the coating apparatus 1 according to the first embodiment of the present disclosure will be described below with reference to FIGS. 2 and 3. FIGS. 2 and 3 are schematic cross-sectional views of a configuration of the pulse valve 10 according to the first embodiment of the present disclosure.

As illustrated in FIG. 2, the pulse valve 10 according to the present embodiment includes a housing 110 including a channel 112 for a fluid to be discharged, a nozzle 120 attached to the front end side of the housing 110 to discharge the fluid to be discharged, a needle 130 inserted into the housing 110 to open and close the channel 112 of the housing 110, a driver 140 to move the needle 130 forward and backward, and a heat insulation flange 150 disposed between the housing 110 and the driver 140. The fluid to be discharged in the present embodiment is a mixture of supercritical carbon dioxide and resin. The mixture serves as a “fluid including a supercritical fluid”.

In at least some embodiments, the pulse valve further includes a heat insulation flange between the housing and the driver.

In FIGS. 2 and 3, directions may be indicated by an X-axis, a Y-axis, and a Z-axis perpendicular to each other. The X-direction illustrated in FIGS. 2 and 3 corresponds to the front-rear direction of the pulse valve 10. In the X-axis direction, a side to which an arrow is directed is referred to as a +X-direction side, and another side opposite to the +X-direction side is referred to as a −X-direction side. The Y-direction corresponds to the width direction of the pulse valve 10. In the Y-axis direction, a side to which an arrow is directed is referred to as a +Y-direction side, and another side opposite to the +Y-direction side is referred to as a −Y-direction side. The Z direction corresponds to the height direction of the pulse valve 10. In the Z-axis direction, a side to which an arrow is directed is referred to as a +Z-direction side, and another side opposite to the +Z-direction side is referred to as a −Z-direction side.

### Housing

The housing 110 is disposed at the front end of the pulse valve 10 and is a housing that accommodates the mixture introduced from a ⅛-inch pipe 441. The top surface (i.e., the forefront surface in the +X-direction side) of the housing 110 faces the base material 12.

The housing 110 has a base 111. Further, a channel 112 for the mixture to be discharged is formed inside the base 111. The channel 112 according to the present embodiment is formed to extend in the X-direction. Further, a first hole 113 recessed toward the channel 112 is formed in the top surface (i.e., the uppermost surface in the +Z-direction side) of the base 111 as a recessed form. The ⅛-inch pipe 441 attached to the end of the pipe 41 is inserted into the first hole 113. The ⅛-inch pipe 441 inserted into the first hole 113 communicates with the channel 112. The pipe 41 and the ⅛ inch pipe 441 may be collectively referred to as “the pipe 41”. Accordingly, the mixture flowing through the pipe 41 is introduced into the channel 112. The pipe communicating with the channel 112 may be a pipe having a size or shape other than the ⅛-inch pipe.

The first hole 113 has a tapered portion 113T whose diameter decreases toward the −Z-direction side, i.e., toward the channel 112. Further, it is preferable that the ⅛-inch pipe 441 be fitted into the first hole 113 via a connection ferrule which is pressure-deformed when the connection ferrule contacts the tapered portion 113T of the first hole 113. A mixture with high temperature and high pressure flows through the ⅛-inch pipe 441. Since the ⅛-inch pipe 441 is fitted into the first hole 113 via the connection ferrule, the ⅛-inch pipe 441 does not detach from the first hole 113 even when a mixture with high temperature and high pressure flows.

A region of the base 111 with which the first hole 113 is provided may be heated by a heating mechanism (e.g., a heating block). By providing a heating mechanism, the temperature of the mixture flowing through the ⅛-inch pipe 441 can be prevented from decreasing.

The housing 110 includes a block 114 at a position closer to the front end in the +X-direction than the base 111. The block 114 is attached to the base 111 via a screw 115a and a screw 115b.

A second hole 116 recessed toward the −X-direction side (i.e., toward the channel 112) is formed at the top surface of the block 114 (i.e., the top surface of the housing 110) in a recessed form. The second hole 116 according to the present embodiment is formed to extend in the X-direction. The nozzle 120 is inserted into the second hole 116. The second hole 116 serves as a “hole”.

The pressure of the mixture accommodated in the housing 110 is preferably 60 MPa or less. The temperature of the mixture accommodated in the housing 110 is preferably 250° C. or less. However, the high-pressure container is not limited thereto.

### Nozzle

The nozzle 120 includes a nozzle base 121 extending in the X-direction while the nozzle 120 is being inserted into the second hole 116. Further, a pressing connection screw is formed around the periphery of the nozzle base 121. The nozzle 120 is fitted into the second hole 116 while pressing by engaging the screw groove of the connection screw in the nozzle base 121 with the screw groove formed in the second hole 116.

A nozzle pipe 122 having a tube shape and extending in the X-direction is formed inside the nozzle base 121. As illustrated in FIG. 3, the nozzle pipe 122 includes a first pipe 122a communicating with the tip of the channel 112, and a second pipe 122b concentric with the first pipe 122a and provided outside the first pipe 122a. The front end of the second pipe 122b corresponds to the nozzle hole 123 for discharging the mixture to the base material 12.

The nozzle pipe 122 has a double-pipe structure including the first pipe 122a and the second pipe 122b. With such a double-pipe structure, the strength of the nozzle pipe 122 can be increased. Further, the discharge stability of the mixture supplied from the channel 112 can be increased.

In at least some embodiments, in the pulse valve, the nozzle pipe has a double-pipe structure including: a first pipe communicating with the channel; and a second pipe surrounding a part of the first pipe, the second pipe having the nozzle hole.

Preferably, the nozzle hole 123 has a diameter of 5 μm or more and 500 μm or less. Further, preferably, the nozzle hole 123 has a diameter of 100 μm or more and 300 μm or less, and more preferably, 150 μm or more and 250 μm or less.

In at least some embodiments, in the pulse valve, the nozzle hole has a diameter of 5 μm or more and 500 μm or less.

When the diameter of the nozzle hole 123 is less than 5 μm, it is not preferable because the diameter is so small that a stable discharge of the mixture may be prevented. Further, when the diameter of the nozzle hole 123 exceeds 500 μm, the thickness of the region of the nozzle 120 excluding the nozzle hole 123 becomes thin, and the nozzle may not resist the pressure at the time of discharging the mixture.

The nozzle 120 includes a connection ferrule 124 disposed around the periphery of the nozzle pipe 122. As illustrated in FIGS. 2 and 3, the connection ferrule 124 is, for example, a stainless steel connection ferrule having a substantially truncated cone shape whose diameter decreases in the −X-direction.

When the nozzle 120 is fitted into the second hole 116 while pressing, the connection ferrule 124 collides with the tapered portion 116T of the second hole 116. After the connection ferrule 124 collides with the tapered portion 116T, the connection ferrule 124 further moves to the inner side of the second hole 116 and is inserted into the inside of the tapered portion 116T. As a result, the connection ferrule 124 is pressure-deformed so as to be compressed by the tapered portion 116T of the second hole 116. Accordingly, further movement of the connection ferrule 124 is prevented. As a result, the nozzle 120 is fitted into the second hole 116 and firmly fixed to the block 114.

Since the nozzle 120 is fixed to the block 114 of the housing 110 via the connection ferrule 124, pressure resistance and durability can be increased. In particular, since a high-pressure mixture flows through the nozzle 120, the connection between the nozzle 120 and the housing 110 via the connection ferrule 124 is preferable. The connection ferrule 124 is fixed and pressed along a moving direction of the needle 130 and the extension bar 141 with an orifice 131 interposed therebetween. As a result, even under a high-pressure and high-temperature environment, detachment of the nozzle 120 including the connection ferrule 124 can be prevented.

It is preferable that a film having a Vickers hardness of 2000 Hv or more is formed on the inner surface of the nozzle pipe 122 to contact the mixture. Examples of the film having a Vickers hardness of 2000 Hv or more include ceramic films such as titanium carbide (SiC) films, titanium nitride (TiN) films, titanium carbide nitride (TiCN) films, titanium aluminum nitride (TiAlN) films, cermet films containing SiC, TiN, TiCN, or TiAlN, and films containing amorphous carbon such as diamond-like carbon (DLC). On the inner surface of the nozzle pipe 122, it is preferable that a film having a Vickers hardness of 2000 Hv or more is formed over the inner surface of the first pipe 122a and the inner surface of the second pipe 122b.

In at least some embodiments, a pulse valve includes: a housing having: a channel through which a fluid flows in a discharge direction; and a hole recessed toward the channel in an opposite direction opposite to the discharge direction; and a nozzle, fitted into the hole in the opposite direction, the nozzle including: a nozzle pipe having: a nozzle hole, at one end of the nozzle pipe in the discharge direction, from which the fluid flowing through the channel is discharged in the discharge direction; and another end communicating with the channel in the discharge direction; and a connection ferrule at a periphery of the nozzle pipe and fixed to the housing.

In at least some embodiments, in the pulse valve, the nozzle pipe has an inner surface coated with a coating having a Vickers hardness of 2000 Hv or more.

In at least some embodiments, in the pulse valve, a periphery of the nozzle hole of the nozzle pipe is coated with a coating having a Vickers hardness of 2000 Hv or more.

Preferably, a film having a Vickers hardness of 2000 Hv or more is also formed around the nozzle hole 123 in the nozzle 120. The nozzle hole 123 illustrated in the drawing is exposed on the surface of the end wall 121F (see FIG. 3) of the nozzle base 121. Thus, as the periphery of the nozzle hole 123 in the nozzle 120, for example, the periphery of the nozzle hole 123 on the surface of the end wall 121F of the nozzle base 121 can be given.

Similarly, the film formed around the nozzle hole 123 may be a SiC film, a TiN film, a TiCN film, a ceramic film of, e.g., TiAlN, a cermet film containing SiC, TiN, TiCN, or TiAlN, or a film containing amorphous carbon such as DLC. A film other than these may be used.

Since a film having a Vickers hardness of 2000 Hv or more is formed on the inner surface of the nozzle pipe 122 and the periphery of the nozzle hole 123, adhesion of the residue of the mixture to the inner surface of the nozzle pipe 122 and the periphery of the nozzle hole 123 can be prevented. Thus, the flow of the mixture passing through the nozzle pipe 122 and the nozzle hole 123 can be prevented, and a desired amount of the mixture can be stably discharged from the nozzle hole 123.

Preferably, the film having a Vickers hardness of 2000 Hv or more has a film thickness of, for example, 0.1 μm or more and 10 μm or less, and more preferably 0.5 μm or more and 5.0 μm or less. By limiting the film thickness of the film having a Vickers hardness of 2000 Hv or more within the above range, the film can be formed without substantially changing the surface shape of a minute surface such as the inner surface of the nozzle pipe 122. As a result, the influence on the discharging stability caused by the formation of the film having a Vickers hardness of 2000 Hv or more can be reduced.

A method for forming a film having a Vickers hardness of 2000 Hv or more is not limited to a specific method. Examples of the method include a physical vapor deposition (PVD) method such as a vacuum deposition method. By using the PVD method, a thin film having a uniform film thickness can be formed even on a minute surface such as the inner surface of the nozzle pipe 122. As a result, the thin film having a uniform film thickness can more effectively prevent a portion of the mixture from remaining on the inner surface of the nozzle pipe 122 and around the nozzle hole 123.

Before a film having a Vickers hardness of 2000 Hv or more is formed, a surface modification treatment such as a blasting treatment or a polishing treatment may be applied to the inner surface of the nozzle pipe 122 and the periphery of the nozzle hole 123. As a result, the adhesion of the film having a Vickers hardness of 2000 Hv or more can be increased.

### Needle

The needle 130 is inserted into the housing 110 and functions as a valve to open and close the channel 112 of the housing 110.

Specifically, when the needle 130 moves forward, the tip of the needle 130 closes a hole such as a microhole 132 of the orifice 131 disposed between the channel 112 and the rear end of the nozzle pipe 122 of the nozzle 120. As a result, the channel 112 is closed. Then, as the needle 130 moves backward, the tip of the needle 130 is separated from the orifice 131. Thus, the microhole 132 of the orifice 131 is opened, and the channel 112 is opened.

A predetermined amount of mixture among the mixture having reached the channel 112 can be supplied to the nozzle 120 by the operation of opening and closing the channel 112 by the needle 130. The response speed (i.e., valve opening time) of the needle 130 is preferably 100 us or less.

The needle 130 is preferably made of a high-strength ceramic such as zirconia from the aspect of, for example, durability and pressure resistance. The orifice 131 with which the tip of the needle 130 collides is preferably made of a high-strength ceramic. Preferably, the ceramic of the orifice 131 has a Vickers hardness of 700 Hv or more, a thermal shock temperature difference of 100° C. or more, and an average linear expansion coefficient of 11×10^{-6/}K or less. Examples of the ceramic include zirconia, alumina, mullite, and cordierite. The thermal shock temperature difference is measured according to, for example, a thermal shock test method based on a relative method specified in JIS R 1648:2002 (“Testing method for thermal shock resistance of fine ceramics”).

In at least some embodiments, the pulse valve further includes an orifice between the channel and the nozzle pipe, The orifice is made of ceramics has a hole communicating with the nozzle pipe. The orifice has: a Vickers hardness of 700 Hv or more; thermal shock resistance of 100° C. or more; and an average thermal expansion coefficient of 11×10⁻⁶/K or less.

Since the orifice 131 is made of a ceramic having the characteristics described above, mechanical and thermal characteristics such as durability, thermal shock resistance, and thermal deformation resistance of the orifice 131 can be increased. Accordingly, a failure that the orifice 131 may be deformed or damaged when the orifice 131 collides with the needle 130 during the discharge operation and the mixture may leak out from the orifice 131 can be prevented.

The upper limit of the Vickers hardness of the ceramic of the orifice 131 is, for example, 2200 Hv or less. The upper limit of the thermal shock temperature difference of the ceramic of the orifice 131 is, for example, 450° C. or less. The lower limit of the average linear expansion coefficient of the ceramic of the orifice 131 is, for example, 4.0×10⁻⁶/K or more. Driver

The driver 140 is a driving mechanism connected to the needle 130 and moves the needle 130 forward and backward. Specifically, as illustrated in FIG. 2, the driver 140 includes an extension bar 141 having a long cylindrical shape and connected to the rear end of the needle 130, and a piezoelectric actuator 142 that moves the extension bar 141 forward and backward at a predetermined speed.

In at least some embodiments, the pulse valve includes: a needle inserted into the housing to openably close the channel in the housing; and a driver including: an extension bar made of invar and connected to the needle; and an actuator to move the extension bar and the needle back and forth in the opposite direction and the discharge direction.

In at least some embodiments, in the pulse valve, the actuator includes a piezoelectric actuator.

The extension bar 141 is preferably made of a material having a low thermal expansion coefficient to avoid thermal expansion due to heat transfer from the needle in contact with the mixture. Examples of the material having a low thermal expansion coefficient include an invar material that is an alloy of iron and nickel, or a super invar material that is an alloy of iron, nickel, and cobalt. Among these materials, a super invar material having an extremely low thermal expansion coefficient is preferable.

A mixture having a temperature of, for example, about 250° C. flows through the channel 112. The tip of the needle 130 is inserted into the channel 112 and contacts the mixture. On the other hand, the extension bar 141 is installed continuously with the needle 130. Thus, heat from the mixture is transferred to the extension bar 141 via the needle 130. At this time, if the extension bar 141 is largely thermally expanded, the advancing-and-retreating range of the needle 130 is also changed as the advancing-and-retreating range of the extension bar 141 is changed. As a result, there is a case where a predetermined amount of mixture among the mixture accommodated in the channel 112 cannot be accurately supplied to the nozzle 120. By contrast, if the extension bar 141 is made of a material having a low thermal expansion coefficient, such as a super invar material, the thermal expansion can be less likely to occur even if the heat of the mixture is transferred from the needle 130. As a result, the predetermined amount of the mixture can be accurately supplied to the nozzle 120.

Further, since the extension bar 141 is made of a material that can reduce thermal expansion, for example, a super invar material, the operation stability of the piezoelectric actuator 142 can be maintained.

The piezoelectric actuator 142 includes, for example, a piezoelectric element that expands and contracts in response to the application of a pulse-like voltage signal. The piezoelectric actuator 142 in the present embodiment is deformed in the X-direction (i.e., expansion and contraction). The piezoelectric actuator 142 is preferably a ring actuator disposed around the periphery of the extension bar 141. By using a ring actuator as the piezoelectric actuator 142, the piezoelectric actuator 142 does not have sharp corners and the load during operation is uniformly distributed over the overall surface, so that durability can be increased. Further, since the piezoelectric actuator 142 can be formed of a thin piezoelectric element layer, a large amount of displacement can be obtained at a low voltage.

In at least some embodiments, in the pulse valve, the piezoelectric actuator includes a ring actuator disposed around a periphery of the extension bar.

In the present embodiment, the piezoelectric actuator 142 is used as the actuator of the driver 140, but other types of actuator may be used. However, from the aspect to achieve a fast response to open and close the valve, which is less than about 100 μs, it is preferable to use the piezoelectric actuator 142.

### Heat Insulation Flange

The heat insulation flange 150 prevents heat from being transferred from the housing 110 to the piezoelectric actuator 142. The material of the heat insulation flange 150 is not limited to any particular material but is preferably made of a ceramic having high-heat insulation properties. Although the piezoelectric actuator 142 has low heat resistance, the heat transfer to the piezoelectric actuator 142 from the mixture can be prevented by disposing the heat insulation flange 150 between the housing 110 and the piezoelectric actuator 142. As a result, the operation stability of the piezoelectric actuator 142 can be obtained.

### Second Embodiment

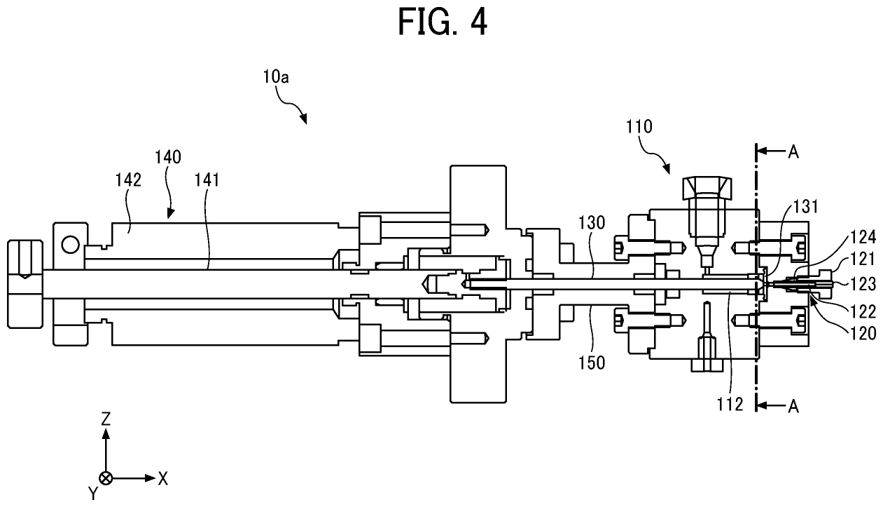

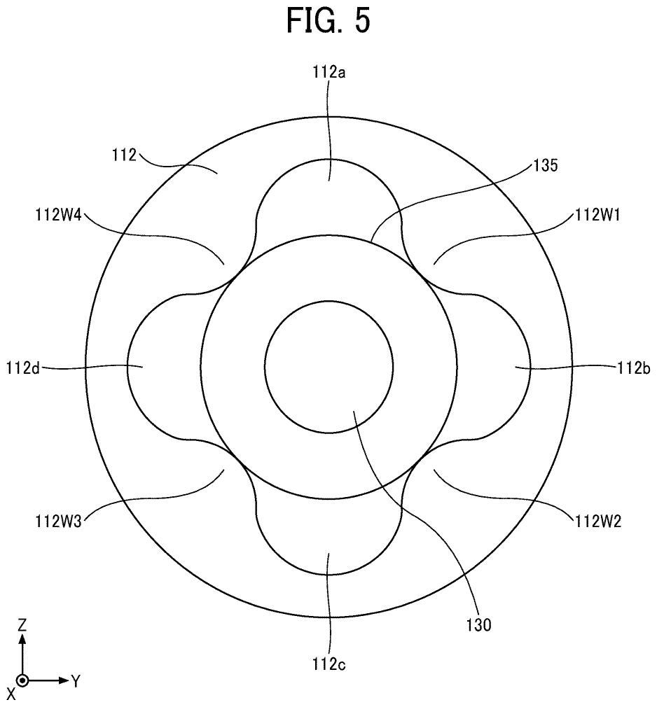

A pulse valve 10a according to a second embodiment of the present disclosure will be described below with reference to FIGS. 4 and 5. FIG. 4 is a schematic cross-sectional view of the pulse valve 10a according to the second embodiment of the present disclosure. FIG. 5 is a sectional view of the pulse valve 10a cut along a line A-A illustrated in FIG. 4.

As illustrated in FIG. 5, the channel 112 includes multiple divided channels 112a to 112d each extending in the X-direction. The positions of the multiple divided channels 112a to 112d are, but not limited to, the end region near an orifice 131 in the channel 112.

The multiple divided channels 112a to 112d are disposed in a circumferential direction of the needle 130 and are formed by gaps radially extending outward from a peripheral wall 135 of a needle 130. For example, a boundary wall 112W1 is disposed between the divided channel 112a and the divided channel 112b, a boundary wall 112W2 is disposed between the divided channel 112b and the divided channel 112c, a boundary wall 112W3 is disposed between the divided channel 112c and the divided channel 112d, and a boundary wall 112W4 is disposed between the divided channel 112d and the divided channel 112a. As described above, each of the boundary walls 112W1, 112W2, 112W3, and 112W4 is disposed between adjacent two of the divided channels 112a to 112d and contacts the peripheral wall 135. Accordingly, the needle 130 can be guided to the center of the channel 112 even after moving forward and backward. As a result, the desired amount of the mixture can be accurately supplied to the nozzle 120.

In at least some embodiments, in the pulse valve, the channel includes multiple divisional channels disposed around a peripheral wall of the needle in a circumferential direction of the peripheral wall of the needle, the multiple divisional channels have boundary walls to divide adjacent multiple divisional channels, and the boundary walls contact the peripheral wall the needle to guide the needle.

### Third Embodiment

### Configuration of Pulse Valve

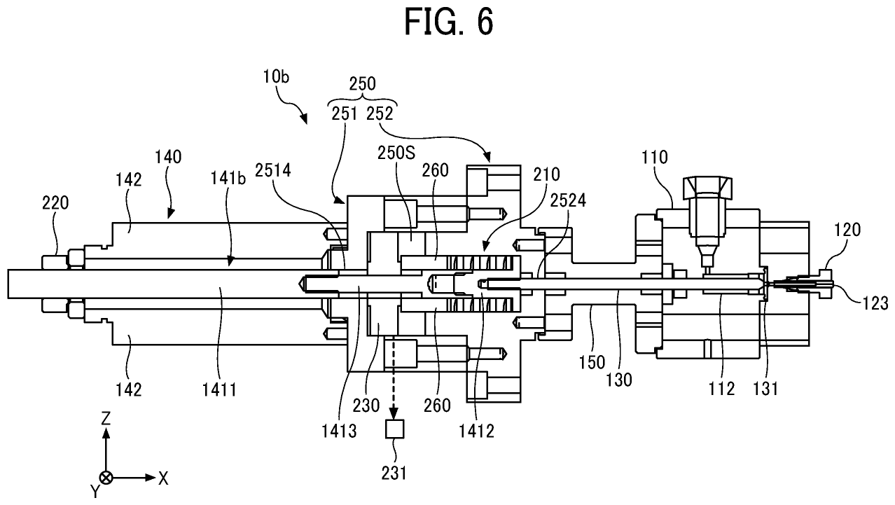

A pulse valve 10b according to a third embodiment of the present disclosure will be described below with reference to FIG. 6. FIG. 6 is a schematic cross-sectional view of the pulse valve 10b according to the third embodiment of the present disclosure. With respect to the first and second embodiments of the present disclosure, the same or like reference signs denote like elements having substantially the same or corresponding functions and configurations, and descriptions of the third embodiment of the present disclosure may be omitted.

As illustrated in FIG. 6, the pulse valve 10b according to the third embodiment includes a housing 110 having a channel 112, a nozzle 120, a needle 130, a driver 140, a spring 210 (serving as a biasing element), a screw 220 (serving as an adjusting element), a first measuring device 230, and an output device 231. The pulse valve 10b may further include a spring housing 250 and a spacer 260.

In at least some embodiments, the pulse valve further includes: a biasing element connected to the extension bar; an adjuster to move the extension bar to adjust an amount of expansion and contraction of the biasing element in the discharge direction and the opposite direction; a measuring device to measure at least one of: a reaction force corresponding to the amount of expansion and contraction of the biasing element; or a deformation amount of a component deformed by the reaction force; and an output device to output a measurement result output from the measuring device.

### Spring Housing

The spring housing 250 accommodates components such as the spring 210, the first measuring device 230, and the spacer 260. The spring housing 250 is disposed between the driver 140 and a heat insulation flange 150. The driver 140 and the heat insulation flange 150 are connected to each other via the spring housing 250.

The spring housing 250 includes a base 251 and a lid 252. The base 251 has a cylindrical shape having an opening at the front end side (+X-direction side) and a recessed portion recessed in the −X-direction. The lid 252 covers the opening of the base 251. Covering the opening of the base 251 with the lid 252 creates a space 250S that accommodates components such as the spring 210, the first measuring device 230, and the spacer 260.

In the space 250S, the spring 210, the spacer 260, and the first measuring device 230 are arranged in this order from the lid 252 to the base 251. The spring 210 is in contact with the spacer 260. The spacer 260 is in contact with the first measuring device 230. A spring reaction force generated by the expansion and contraction of the spring 210 is applied to each of the spacer 260 and the first measuring device 230. However, the arrangement of the spring 210, the spacer 260, and the first measuring device 230 are not limited to the above-described arrangement. The spring reaction force serves as “reaction force.”

### Extension Bar

The extension bar 141b of the driver 140 includes a main body 1411, a needle receiver 1412, and an intermediate portion 1413. The main body 1411 is disposed on the rear end side (i.e., −X-direction side) and inserted into the piezoelectric actuator 142. The needle receiver 1412 is disposed on the front end side (i.e., +X-direction side) and supports the needle 130. The intermediate portion 1413 connects the main body 1411 and the needle receiver 1412.

The main body 1411 is connected to a screw 220 in contact with the rear end surface (i.e., the surface of the −X-direction side) of the piezoelectric actuator 142. The needle receiver 1412 is accommodated in the space 250S of the spring housing 250 and is connected to the needle 130 inserted into a through hole 2524 provided with the lid 252. The intermediate portion 1413 is inserted into a through hole 2514 provided with the base 251 and passes through the first measuring device 230 and the spacer 260.

### Spring

The spring 210 is connected to the extension bar 141b. The spring 210 illustrated in FIG. 6 is connected to the needle receiver 1412 of the extension bar 141b. The type of the spring 210 is not limited to any particular type of spring. Examples of the spring 210 include a spiral spring. The spring 210 is disposed in the space 250S of the spring housing 250 so as to expand and contract in the X-direction.

### Screw

The screw 220 moves the extension bar 141b to adjust the expansion-and-contraction amount Δx of the spring 210. The screw groove formed on the inner surface of the screw 220 is engaged with the screw groove formed on the surface of the main body 1411 of the extension bar 141b. For example, when the screw 220 is rotated in a predetermined direction, the main body 1411 is moved backward. On the contrary, when the screw 220 is rotated in the direction opposite to the predetermined direction, the main body 1411 moves forward. In other words, the main body 1411, the intermediate portion 1413, and the needle receiver 1412 move in accordance with the rotation of the screw 220. The spring 210 is expanded and contracted as the needle receiver 1412 moves. At the same time, the needle 130 moves. As a result, the needle 130 is released from the orifice 131 and the mixture flows into the space between the needle 130 and the orifice 131. The amount of the mixture that has flowed into the space between the needle 130 and the orifice 131 varies depending on the position of the tip of the needle 130 after the movement. The mixture flowing into the space between the needle 130 and the orifice 131 passes through the nozzle 120 and is discharged from the nozzle hole 123 to the outside. Thus, the discharge amount of the mixture changes depending on the position of the tip of the needle 130. The position of the tip of the needle 130 is determined depending on the expansion-and-contraction amount Δx of the spring 210. In other words, the expansion-and-contraction amount Δx of the spring 210 and the position of the tip of the needle 130 can be adjusted according to the rotation amount of the screw 220.

### First Measuring Device

The first measuring device 230 measures a spring reaction force corresponding to the expansion-and-contraction amount Δx of the spring 210. The first measuring device 230 is, for example, a load cell that measures a spring reaction force received from the spring 210. However, the first measuring device 230 is not limited to the load cell. The first measuring device 230 serves as a “measuring device”.

The first measuring device 230 includes a strain body deformed by receiving a spring reaction force, a strain gauge that is attached to the surface of the strain body and measures the strain of the strain body, and a calculator that calculates the spring reaction force received from the spring 210 based on the measurement result of the strain gauge. Since the spring constant of the spring 210 to be used is known, the calculator may calculate the expansion-and-contraction amount Δx of the spring 210 based on the spring reaction force and the spring constant of the spring 210.

### Output Device

The output device 231 outputs the measurement result by the first measuring device 230. The output device 231 is, for example, a monitor that displays the spring reaction force, the expansion-and-contraction amount Δx of the spring 210, and the rotation amount of the screw 220 corresponding to the expansion-and-contraction amount Δx of the spring 210, which are measurement results of the first measuring device 230. However, the output device 231 is not limited to the monitor. The output device 231 may be combined with the first measuring device 230 as a single device.

### Effects and Other Matters

When the screw 220 is rotated to expand or contract the spring 210 by the expansion-and-contraction amount Δx, the mixture is discharged from the pulse valve 10b, and the discharge amount of the mixture at that time is separately measured. Accordingly, the correspondence between the expansion-and-contraction amount Δx of the spring 210 and the discharge amount of the mixture can be quantitatively grasped. In other words, the rotation amount of the screw 220 and the amount of discharge of the mixture can be quantitatively associated with each other. As a result, the amount of mixture discharged according to the rotation amount of the screw 220 can be grasped, and the accuracy of adjusting the amount of mixture discharged by the rotation of the screw 220 can be increased.

The rotation of the screw 220 may be performed manually or by a driver such as a motor. When the screw 220 is rotated by the driver, the first measuring device 230 may transmit the measurement result of the spring reaction force to an information processing device (e.g., circuitry) that controls the operation of the driver. The information processing device calculates the rotation amount of the screw 220 for controlling the amount of the mixture discharged from the pulse valve 10b based on the measurement result transmitted from the first measuring device 230. The information processing device transmits a control signal including the calculated rotation amount of the screw 220 to the driver. Accordingly, the driver rotates the screw 220 by the rotation amount of the screw 220 based on the control signal output from the information processing device.

### Modification of Third Embodiment

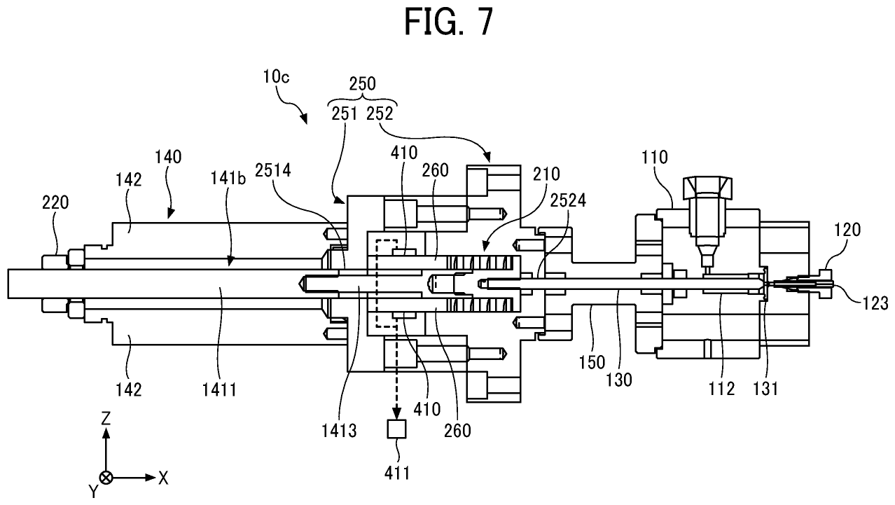

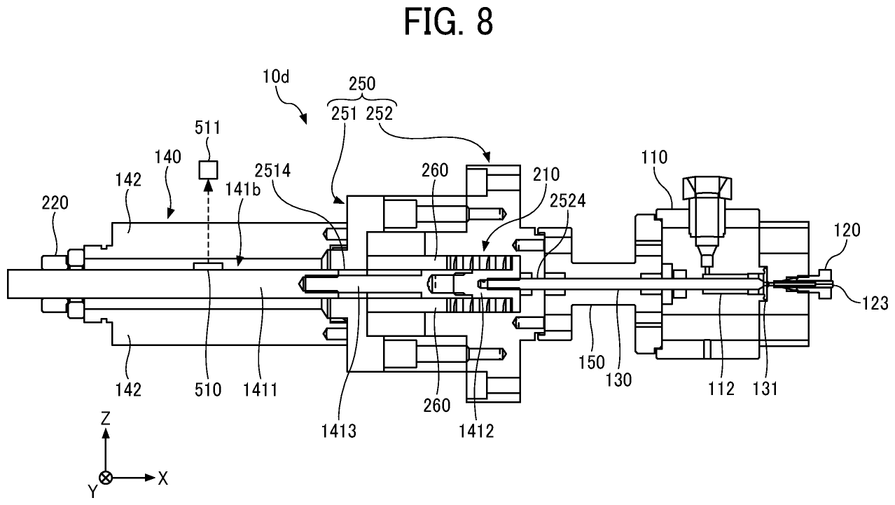

A pulse valve 10c according to a first modification of the third embodiment and a pulse valve 10d according to a second modification of the third embodiment are described with reference to FIGS. 7 and 8. FIG. 7 is a schematic cross-sectional view of the pulse valve 10c, according to the first modification of the third embodiment of the present disclosure. FIG. 8 is a schematic cross-sectional view of the pulse valve 10d, according to the second modification of the third embodiment of the present disclosure.

As illustrated in FIG. 7, the pulse valve 10c according to the first modification of the third embodiment includes a second measuring device 410 that measures the deformation amount of the spacer 260 caused by the spring reaction force corresponding to the expansion-and-contraction amount Δx of the spring 210, and an output device 411 that outputs the measurement result of the second measuring device 410. Examples of the second measuring device 410 include a strain gauge disposed on the surface of the spacer 260 to measure the deformation amount of the spacer 260. However, the second measuring device 410 is not limited to the strain gauge. The second measuring device 410 serves as a “measuring device.” The spacer 260 serves as a “component that deforms when receiving reaction force.” Examples of the output device 411 include a monitor that is separate from or integral with the second measuring device 410.

Also, in the first modification of the third embodiment, the discharge amount of the mixture discharged from the pulse valve 10c is separately measured. Accordingly, the correspondence between the deformation amount of the spacer 260 measured by the second measuring device 410 and the discharge amount of the mixture can be quantitatively grasped. In other words, the rotation amount of the screw 220 and the amount of discharge of the mixture can be quantitatively associated with each other. As a result, the discharge amount of the mixture corresponding to the rotation amount of the screw 220 is obtained, and the adjustment accuracy of the discharge amount of the mixture can be increased.

As illustrated in FIG. 8, the pulse valve 10d according to the second modification of the third embodiment includes a third measuring device 510 that measures the deformation amount of the extension bar 141b caused by the spring reaction force corresponding to the expansion-and-contraction amount Δx of the spring 210, and an output device 511 that outputs the measurement result of the third measuring device 510. Examples of the third measuring device 510 include a strain gauge that is disposed on the surface of the extension bar 141b and measures the deformation amount of the extension bar 141b. However, the third measuring device 510 is not limited to the strain gauge. The third measuring device serves as a “measuring device.” The extension bar 141b serves as a “component that deforms when receiving reaction force.” Examples of the output device 511 include a monitor that is separate from or integral with the third measuring device 510.

Also, in the second modification of the third embodiment, the discharge amount of the mixture discharged from the pulse valve 10d is separately measured. Accordingly, the correspondence between the deformation amount of the extension bar 141b measured by the third measuring device 510 and the discharge amount of the mixture can be quantitatively obtained. In other words, the rotation amount of the screw 220 and the discharge amount of the mixture can be quantitatively associated with each other. As a result, the discharge amount of the mixture corresponding to the rotation amount of the screw 220 is obtained, and the adjustment accuracy of the discharge amount of the mixture can be increased.

### EXAMPLE

The present disclosure will be described below in more detail according to some examples, but the present disclosure is not limited to the examples.

Crystalline polyester prepared by dehydration condensation of ethylene glycol and dodecanedioic acid was introduced into a high-pressure container 6 (serving as an autoclave). The crystalline polyester was melted at 250° C., and the pressure in the system including the high-pressure container 6 was reduced to remove air. The molten state of the crystalline polyester was confirmed by the saturation of the value of the torque meter 23.

Supercritical carbon dioxide was introduced into the high-pressure container 6, the pressure in the system including the high-pressure container 6 was increased to 50 MPa, and the supercritical carbon dioxide and the crystalline polyester were mixed. The mixing uniformity was confirmed by the saturation of the value of the torque meter 23.

After the mixture was uniformly mixed, the mixture was introduced into the pulse valve 10, and the pressure was stabilized at 50 MPa while closing the channel 112 of the pulse valve 10 by the needle 130. The piezoelectric actuator 142 was driven to retract the needle 130 to open the channel 112. As a result, the mixture was supplied to the nozzle 120 and jetted from the nozzle hole 123.

When the application of the voltage pulse to the piezoelectric actuator 142 was stopped and the jetting was stopped, there was no leakage of the mixture from the nozzle 120. Further, even when a rectangular pulse voltage of 100 μs was applied to the piezoelectric actuator 142, the piezoelectric actuator 142 operated stably and the jetting of the mixture was confirmed.

Although the embodiments have been described above, the embodiments of the present disclosure are not limited to the configurations described above. The embodiments of the present disclosure may be modified without departing from the scope or spirit of the disclosure and may be determined appropriately in accordance with applications.

Aspects of the present disclosure are as follows, for example.

In a first aspect, a pulse valve includes: a housing having: a channel in which a fluid flows; a hole recessed toward the channel; and a nozzle fitted in the hole to discharge the fluid flowing in the channel. The nozzle includes: a nozzle pipe having one end with a nozzle hole and another end to communicate with the channel; and a connection ferrule disposed on a periphery of the nozzle pipe to fix the nozzle to the housing.

In a second aspect, in the pulse valve according to claim the first aspect, the nozzle pipe has a double-pipe structure including: a first pipe to communicate with the channel; and a second pipe having the nozzle hole and disposed outside of the first pipe.

In a third aspect, in the pulse valve according to the first or second aspect, the nozzle hole has a diameter of 5 μm or more and 500 μm or less.

In a fourth aspect, the pulse valve according to any one of the first to third aspects includes: a needle inserted into the housing, the needle to open and close the channel; and a driver including: an extension bar to connect with the needle, the extension bar being made of invar; and an actuator to move the extension bar forward and backward. The driver moves the needle forward and backward.

In a fifth aspect, in the pulse valve according to the fourth aspect, the actuator includes a piezoelectric actuator.

In the sixth aspect, in the pulse valve according to the fifth aspect, the piezoelectric actuator includes a ring actuator.

In the seventh aspect, in the pulse valve according to any one of the fourth to sixth aspects, a heat insulation flange is disposed between the housing and the driver.

In an eighth aspect, in the pulse valve according to any one of the fourth to seventh aspects, the channel includes multiple divided channels radially disposed along a peripheral wall of the needle. Each of the multiple divided channels adjacent to each other has a boundary wall contacting the peripheral wall of the needle to guide a position of the needle.

In a ninth aspect, in the pulse valve according to any one of the first to eighth aspects, a coat having a Vickers hardness of 2000 Hv or more is formed at an inner surface of the nozzle pipe and around the nozzle hole of the nozzle.

In a tenth aspect, the pulse valve according to any one of the first to ninth aspects includes an orifice disposed between the channel and the nozzle pipe. The orifice communicates with the nozzle pipe and includes a ceramic having a Vickers hardness of 700 Hv or more, a thermal shock temperature difference of 100° C. or more, and an average thermal expansion coefficient of 11×10⁻⁶/K or less.

In an eleventh aspect, the pulse valve according to any one of the fourth to eighth aspects further includes: a biasing element connecting to the extension bar; an adjuster to move the extension bar and adjust an expansion-and-contraction amount of the biasing element; a measuring device to measure at least one of reaction force corresponding to the expansion-and-contraction amount of the biasing element and a deformation amount of a component deformed by the reaction force; and an output device to output a measurement result by the measuring device.

In a twelfth aspect, a coating apparatus includes: a high-pressure container to generate a mixture of a fluid and a resin; and the pulse valve according to any one of the first to eleventh aspects to discharge the mixture supplied from the high-pressure container.

In a thirteenth aspect, the coating apparatus according to the twelfth aspect includes: a stirrer to stir the mixture; and a torque meter to measure torque of the stirrer while stirring the mixture.

In a fourteenth aspect, a pulse valve includes: a housing having: a channel through which a fluid flows in a discharge direction; and a hole recessed toward the channel in an opposite direction opposite to the discharge direction; and a nozzle, fitted into the hole in the opposite direction, the nozzle including: a nozzle pipe having: a nozzle hole, at one end of the nozzle pipe in the discharge direction, from which the fluid flowing through the channel is discharged in the discharge direction; and another end communicating with the channel in the discharge direction; and a connection ferrule at a periphery of the nozzle pipe and fixed to the housing.

In a fifteenth aspect, in the pulse valve according to the fourteenth aspect, the nozzle pipe has a double-pipe structure including: a first pipe communicating with the channel; and a second pipe surrounding a part of the first pipe, the second pipe having the nozzle hole.

In a sixteenth aspect, in the pulse valve according to the fourteenth or fifteenth aspect, the nozzle hole has a diameter of 5 μm or more and 500 μm or less.

In a seventeenth aspect, the pulse valve according to any one of the fourteenth to sixteenth aspect includes: a needle is inserted into the housing to openably close the channel in the housing; and a driver including: an extension bar made of invar and connected to the needle; and an actuator to move the extension bar and the needle back and forth in the opposite direction and the discharge direction.

In an eighteenth aspect, in the pulse valve according to the seventeenth aspect, the actuator includes a piezoelectric actuator.

In a nineteenth aspect, in the pulse valve according to the eighteenth aspect, the piezoelectric actuator includes a ring actuator disposed around a periphery of the extension bar.

In a twentieth aspect, the pulse valve according to eighteenth aspect, further includes a heat insulation flange between the housing and the driver.

In a twenty-first aspect, in the pulse valve according to any one of the seventeenth to twentieth aspects, the channel includes multiple divisional channels disposed around a peripheral wall of the needle in a circumferential direction of the peripheral wall of the needle, the multiple divisional channels have boundary walls to divide adjacent multiple divisional channels, and the boundary walls contact the peripheral wall the needle to guide the needle.

In a twenty-second aspect, in the pulse valve according any one of the fourteenth to twenty-first aspects, the nozzle pipe has an inner surface coated with a coating having a Vickers hardness of 2000 Hv or more.

In a twenty-third aspect, in the pulse valve according to any one of the fourteenth to twenty-second aspects, a periphery of the nozzle hole of the nozzle pipe is coated with a coating having a Vickers hardness of 2000 Hv or more.

In a twenty-fourth aspect, the pulse valve according to any one of the fourteenth to twenty-third aspect, further includes an orifice between the channel and the nozzle pipe, The orifice is made of ceramics has a hole communicating with the nozzle pipe. The orifice has: a Vickers hardness of 700 Hv or more; thermal shock resistance of 100° C. or more; and an average thermal expansion coefficient of 11×10⁻⁶/K or less.

In a twenty-fifth aspect, in the pulse valve according to any one of the seventeenth to twenty-first aspects, further includes: a biasing element connected to the extension bar; an adjuster to move the extension bar to adjust an amount of expansion and contraction of the biasing element in the discharge direction and the opposite direction; a measuring device to measure at least one of: a reaction force corresponding to the amount of expansion and contraction of the biasing element; or a deformation amount of a component deformed by the reaction force; and an output device to output a measurement result output from the measuring device.

In a twenty-sixth aspect, a coating apparatus includes: the pulse valve according to any one of the fourteenth to twenty-fifth aspects to discharge the fluid from the nozzle hole; a pressure container to: mix a compressed fluid and a resin to generate the fluid; and supply the fluid to the pulse valve.

In a twenty-seventh aspect, in the coating apparatus according to the twenty-sixth aspect, the pressure container includes: a stirrer to stir a mixture of the compressed fluid and the resin to generate the fluid; and a torque meter to measure torque of the stirrer generated by stirring the mixture.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

This patent application is based on and claims priority to Japanese Patent Application No. 2022-190254, filed on Nov. 29, 2022, in the Japan Patent Office, and Japanese Patent Application No. 2023-170614, filed on Sep. 29, 2023, in the Japan Patent Office, the entire disclosure of which is hereby incorporated by reference herein.

### REFERENCE SIGNS LIST

1 Coating apparatus
6 Pressure container
10, 10a, 10b, 10c, 10d Pulse valve
110 Housing
111 Base
112 Channel
112a, 112b, 112c, 112d Divided channel
112W1, 112W2, 112W3, 112W4 Boundary wall
113 First hole
116 Second hole
120 Nozzle
121 Nozzle base
122 Nozzle pipe
123 Nozzle hole
124 Connection ferrule
130 Needle
140 Driver
141, 141b Extension bar
142 Piezoelectric actuator
150 Heat insulation flange
210 Spring
220 Screw
230 First measuring device
231, 411, 511 Output device
250 Spring housing
260 Spacer
410 Second measuring device
510 Third measuring device

1. A pulse valve comprising:
a housing including:
a channel through which a fluid flows in a discharge direction; and
a hole recessed toward the channel in an opposite direction opposite to the discharge direction; and
a nozzle, in the hole in the opposite direction, the nozzle including:
a nozzle pipe including:
a nozzle hole, at one end of the nozzle pipe in the discharge direction, from which the fluid flowing through the channel is discharged in the discharge direction; and
another end communicating with the channel in the discharge direction; and
a connection ferrule at a periphery of the nozzle pipe and fixed to the housing.

2. The pulse valve according to claim 1, wherein the nozzle pipe has a double-pipe structure including:
a first pipe communicating with the channel; and
a second pipe surrounding a part of the first pipe, the second pipe having the nozzle hole.

3. The pulse valve according to claim 1, wherein:
the nozzle hole has a diameter of 5 μm or more and 500 μm or less.

4. The pulse valve according to claim 1 further comprising:
a needle in the housing to openably close the channel in the housing; and
a driver including:
an extension bar including invar and connected to the needle; and
an actuator to move the extension bar and the needle back and forth in the opposite direction and the discharge direction.

5. The pulse valve according to claim 4, wherein:
the actuator includes a piezoelectric actuator.

6. The pulse valve according to claim 5, wherein;
the piezoelectric actuator includes a ring actuator disposed around a periphery of the extension bar.

7. The pulse valve according to claim 4, further comprising:
a heat insulation flange between the housing and the driver.

8. The pulse valve according to claim 4, wherein;
the channel includes multiple divisional channels disposed around a peripheral wall of the needle in a circumferential direction of the peripheral wall of the needle,
the multiple divisional channels have boundary walls to divide adjacent multiple divisional channels, and
the boundary walls contact the peripheral wall the needle to guide the needle.

9. The pulse valve according to claim 1, wherein:
the nozzle pipe includes an inner surface coated with a coating having a Vickers hardness of 2000 Hv or more.

10. The pulse valve according to claim 1, wherein:
a periphery of the nozzle hole of the nozzle pipe is coated with a coating having a Vickers hardness of 2000 Hv or more.

11. The pulse valve according to claim 1, further comprising:
an orifice between the channel and the nozzle pipe,
wherein the orifice includes:
ceramics,
a hole communicating with the nozzle pipe,
a Vickers hardness of 700 Hv or more,
a thermal shock resistance of 100° C. or more, and
an average thermal expansion coefficient of 11×10⁻⁶/K or less.

12. The pulse valve according to claim 4, further comprising:
a biasing element connected to the extension bar;
an adjuster to move the extension bar to adjust an amount of expansion and contraction of the biasing element in the discharge direction and the opposite direction;
measurement circuitry to measure at least one of:
a reaction force corresponding to the amount of expansion and contraction of the biasing element; or
a deformation amount of a component deformed by the reaction force; and
circuitry configured to output a measurement result output from the measurement circuitry.

13. A coating apparatus comprising:
the pulse valve according to claim 1 to discharge the fluid from the nozzle hole; and
a pressure container to:
mix a compressed fluid and a resin to generate the fluid; and
supply the fluid to the pulse valve.

14. The coating apparatus according to claim 13, wherein the pressure container includes:
a stirrer to stir a mixture of the compressed fluid and the resin to generate the fluid; and
a torque meter to measure torque of the stirrer generated by stirring the mixture.
